(19) United States
(12) Patent Application Publication
(10) Pub. No.: US 2016/0126804 A1
(43) Pub. Date: May 5, 2016

(54) Engine

(71) Applicant: Edsel Chromie, Escondido, CA (US)

(72) Inventor: Edsel Chromie, Escondido, CA (US)

(21) Appl. No.: 14/527,596

(22) Filed: Oct. 29, 2014

(51) Int. Cl. H02K 7/00; H02K 1/34; H02K 1/06

(52) U.S. Cl. CPC H02K 7/00; H02K 1/06; H02K 1/34; Y10S 74/09; H02K 53/00

(57) ABSTRACT

A motor for generating rotational force employable for work is provided having a wheel operatively engaged to rotate on an axle and a plurality of magnetic assemblies radially positioned on said wheel between the axle and a circumferential edge. Rotation under force of the wheel is provided by sequential energizing of opposing pairs of magnetic assemblies to translate components engaged therewith to achieve an out of balance state of the wheel and rotation under force.

### FIELD OF THE INVENTION

The present invention is directed to an engine for generating rotational power. More particularly, the disclosed device and method concern the employment of wheel-engaged stationary magnets in combination with magnetically translatable members for the generation of rotational power which may be communicated to an apparatus requiring power to perform work.

### BACKGROUND OF THE INVENTION

In general, an engine is a mechanical apparatus which is adapted to convert communicated energy into useful mechanical motion under a force. Examples of such are a water wheel which converts communicated water flow into rotational energy and an electric motor which converts communicated electrical energy into rotational power.

Conventional motors employ numerous engaged parts to convert communicated energy into a mechanical force output, be it reciprocating or rotational. The electric motor is an example of such a conventional device.

An electric motor employs electrical energy communicated to it from a power plant, battery, generator, or other source, to produce mechanical energy, usually through the interaction of magnetic fields and current-carrying conductors. Electric motors are found modernly in applications as diverse as industrial fans, blowers and pumps, machine tools, household appliances, power tools, and disk drives. They may be powered by direct current (for example a battery powered portable device or motor vehicle), or by alternating current from a central electrical distribution grid.

While the physical principle of production of mechanical force by the interactions of an electric current and a magnetic field was known as early as 1821, it has been a conventional goal to produce electric motors of increasing efficiency since the 19th century. However, more modernly, electrically powered motors have not improved on any great scale. The same is true of other motors providing mechanical power from communicated energy such as water wheels, windmills, and similar devices for the production of employable mechanical energy.

More recently, to reduce the electric energy consumption and other energy consumption used by motors and their associated carbon footprints, regulatory authorities in many countries have implemented legislation to encourage the manufacture of higher efficiency electric motors. However, such improvements have not been overly forthcoming in recent years and energy consumption in most countries is rising despite legislated conservation.

The disclosed device and method herein, overcomes a number of the shortcomings of prior art and provides an improved motor for the generation and communication of employable mechanical force or energy to devices requiring such to do work. The device is highly portable and, due to its inherent generation of rotational mechanical energy, is easily engageable to conventional devices requiring such rotational energy under force to perform work.

It is an established engineering principle that when forces are equal, opposite, and collinear, no resultant moment is produced at any point in space. However, when such forces are manipulated to be out of such equilibrium, then a force may be generated and can be engaged mechanically to devices requiring such force for their function.

The apparatus herein described and disclosed, utilizes this engineering principle in a new and novel fashion in a method and apparatus which is easily engaged to existing devices requiring rotational force and is also portable in smaller sizes. Such rotational energy generation is provided by employing magnetic and electro-mechanical forces in a manner to act on a wheel or disk, to produce a rotation under force of the wheel. The wheel may be engaged mechanically to another device requiring such rotational force.

With respect to the above background description, before explaining at least one preferred embodiment of the motor invention herein in detail, it is to be understood that the invention is not limited in its application to the details of construction and to the arrangement of the components or steps set forth in the following description or illustration in the drawings. The various apparatus and method of the invention are capable of other embodiments and of being practiced and carried out in various ways which will become obvious to those skilled in the art upon review of this disclosure.

Also, it is to be understood that the phraseology and terminology employed herein, are for the purpose of description and should not be regarded as limiting. Therefore, those skilled in the art upon reading this disclosure will appreciate that the conception upon which this disclosure is based, may readily be utilized as a basis fur designing of other devices, methods and systems for imparting rotational force to a wheel. It is important, therefore, that the objects and claims be regarded as including such equivalent construction and methodology in so far as they do not depart from the spirit and scope of the present invention.

Further objectives of this invention will be brought out in the following part of the specification wherein detailed description is for the purpose of fully disclosing the invention without placing limitations thereon.

### SUMMARY OF THE INVENTION

The device, as herein described and disclosed, employs a unique configuration of permanent magnets and magnetically translatable members as a means to impart a rotational force to a wheel operatively engaged with the magnets, translating members, and an axle and frame.

As shown and described herein, the device and method employ a plurality of magnetically activated assemblies located radially about positions on a wheel. In a particularly preferred mode of the device and method which takes advantage of the attractive and repulsive forces of permanent magnets, each assembly in the plurality on the wheel, translatabley positions an elongated permanent magnet member in-between an opposing pair of pole-reversable magnets. The assemblies are as noted radially-located about the wheel at positions in-between the circumferential edge of the wheel, and the wheel axle to which the wheel is rotationally engaged upon a frame. A respective translatable permanent magnet is positioned in a gap located between each respective pair of pole-reversible magnets.

In use, the wheel engaged to the axle has a bottom portion closest to a support surface for the frame and at an elevation below the axle and has a top portion positioned opposite the bottom portion on an opposite side of the axle engaged with the frame. The device and method herein employs a means for continuously generating an out-of-balance condition of the wheel during its rotation on the axle, thereby generating a rotational force to the wheel.

In one means of continually imparting this out of balance condition to the wheel, in a first operation two of the reversible magnets located on an assembly positioned in the bottom portion of the wheel are both energized to a negative polarity. The time duration for this energized state but currently approximately one second, functions well in the method herein. The magnetic negative polarity which results in a lower-positioned negatively-charged electromagnet of the respective pair in the assembly, imparts a repelling force to the negative end of the permanent magnet situated to translate within the assembly.

Concurrently, in this first operation of the assembly, magnetic force from the opposing negatively-charged electromagnet, on the opposite side of the gap in which the translating permanent magnet is located, communicates a significant magnetic attractive force to the positive end of the translating permanent magnet located in the gap therebetween. The combination of attractive and repulsive magnetic forces in the assembly, causes a translation of the permanent magnet member, in a direction toward the attracting electromagnet in the respective pair, and away from the electromagnet communicating the repelling magnetic force to the opposite end of the translating permanent magnet.

In a second operation, concurrent with the first operation, electrical power communicated to a second magnetic assembly having a second opposing pair of energizable electromagnets, located in the top portion of the wheel, is energized. During the time of energizing the electromagnets in this second magnetic assembly, on opposing sides of a respective gap of the second assembly in which the translating permanent magnet is located, the electric power communicated to the opposing electromagnets in this second assembly is switched such that the electromagnet located closest to the circumferential edge of the wheel, will attract the translating electromagnet in the gap, in a direction away from the axle and toward the edge.

Concurrently in this second top-located assembly, the electromagnet, on the opposite side of the gap in this assembly, is communicated an electrical current switched to generate a magnetic force adapted to repel the translating permanent magnet located within the gap of this top-lo located second assembly. The concurrently attractive and repulsive forces upon the translating magnet causes an immediate translation thereof, along a vector toward the circumferential edge of the wheel and away from the axle.

The translation of the magnet in the first assembly in the lower half of the wheel, toward the axle, concurrent with the translation of the magnet in the second assembly in the upper half of the wheel away from the axle, creates an out-of-balance condition on the rotationally engaged wheel. Depending on the location of the opposing quadrants of the wheel, in which the magnetic assemblies are located, relative to a perpendicular center line running through the axle, a directional rotation is imparted to the wheel under the force generated by this out of balance condition.

Subsequent to the concurrent first and second operations of the first and second assemblies, the respective permanent magnet located within the gap between each respective pair of electromagnets in each assembly located on opposite sides of the wheel, will remain attached to the electromagnet to which it was electromagnetically forced. The respective permanent magnets in-between each pair of electromagnets of each magnetic assembly, will remain in this attached state until the respective assemblies rotate to the opposite quadrant on the wheel, and the polarity of the electrical current to the electromagnets in each respective assembly is reversed from the prior operation, thereby repelling the translating permanent magnet from the magnetic contact with one electromagnet to a contact and magnetic attachment with the opposing electromagnet.

It should be noted that translation of the elongated member located in the assemblies might also be provided using a solenoid or linear motor, which when operatively energized will cause a translation of the member therein, toward or away from the circumferential edge, as the case may be. The concurrent translations of the opposing members in each assembly can yield another means to sequentially impart an out-of-balance condition to the rotatable wheel. As such, a magnetically translated member can include any one of a group of such translating members including a permanent magnet, a solenoid, or a linear motor. However, a current preferred mode is the employment of a magnetic member in-between pole-reversible electromagnets of a positioned magnetic assembly, as noted above.

A plurality of such radially located magnetic assemblies, each having such pairs of the electromagnets having a respective magnetically-translated member located in respective gaps therebetween, are each located radially about the wheel, in spaced positions in-between the axle and the circumferential edge of the wheel. The number in the plurality can vary depending on the circumference of the wheel and the amount of rotational force to be generated by the induced out-of-balance condition of the wheel.

In operation, as the wheel rotates, opposing magnetic assemblies radially located around the wheel, having such opposing pairs of electromagnets, sequentially reach respective top and bottom positions. In sequentially timed concurrent first and second operations, activated by electrical switching of the polarity of electrical current communicated to each respective opposing-positioned assembly, at its respective position on the wheel, a continuous out-of-balance condition of the wheel is maintained, and the rotational force thereby generated.

Employing the method herein to provide a means to continually impart an out-of-balance condition to the rotationally engaged wheel, the device and method herein, will continually impart the force generated by the continuously out-of-balance wheel, to generate rotation. The translation of the mass of each respective magnetically-translatable member, in each opposing-located magnetic assembly, in a sequential fashion, will continue this rotation and can be timed to control the speed and force of rotation.

Power for the electric energy requirements of the operation of the opposing pairs of magnetic assemblies, linear motors or solenoids if employed for the translating member, is reduced significantly for the work accomplished and energy provided by the rotating wheel. This is because the permanent magnet will continually impart attraction and repulsion which significantly reduces the energy required to translate the metal member between the electromagnets of each assembly. Such electrical power can be provided by conventional batteries or a connection to an electrical energy supply such as a local grid. In the case of batteries, an electrical generating apparatus engaged with the wheel during rotation such as a generator or alternator, can be operatively connected and employed to charge the battery concurrent during rotation. The wheel itself, using a central axle or circumferential contact, may be engaged to a component requiring mechanical force using belts, chains, gears, or other conventional means for communicating rotational power to a secondary device requiring it.

It is therefore an object of the present invention to provide an apparatus and method to impart rotational movement to an operatively mounted wheel, using minimal electrical energy.

It is a further object of this invention to use a novel configuration of electromagnets and magnetically translatable members, to generate an out-of-balance condition to a wheel and to impart a rotation under force to that wheel in a significantly enhanced fashion yielding significant energy savings over conventional motors.

An additional object of this invention is the provision of a mechanical energy-providing apparatus which is easily transported, maintained and operated.

These together with other objects and advantages which become subsequently apparent reside in the details of the construction and operation of the motor invention herein, as more fully hereinafter described and claimed, reference being had to the accompanying drawings forming a part thereof, wherein like numerals refer to like parts throughout.

### BRIEF DESCRIPTION OF THE DRAWINGS

FIG. 1 while not to scale, is a graphic depiction of opposing magnetic assemblies located radially around a perimeter and on opposing sides of a rotating wheel and one mode of the switching operation of each.

FIG. 2 depicts a graphic depiction of the device herein and radially positioned assemblies in quadrants on a wheel.

FIG. 3 is a front plan view of the device of FIG. 1, an another preferred mode of the device having weights positionable to one of two positions by the movement of the magnetically translating member of the assembly to which they are engaged.

FIG. 4 is top plan view of the device as in FIG. 3, showing a positioning of the weights by the movement of the translating member at an upper position on the wheel, past top-dead-center.

### DETAILED DESCRIPTION OF THE PREFERRED EMBODIMENTS OF THE INVENTION

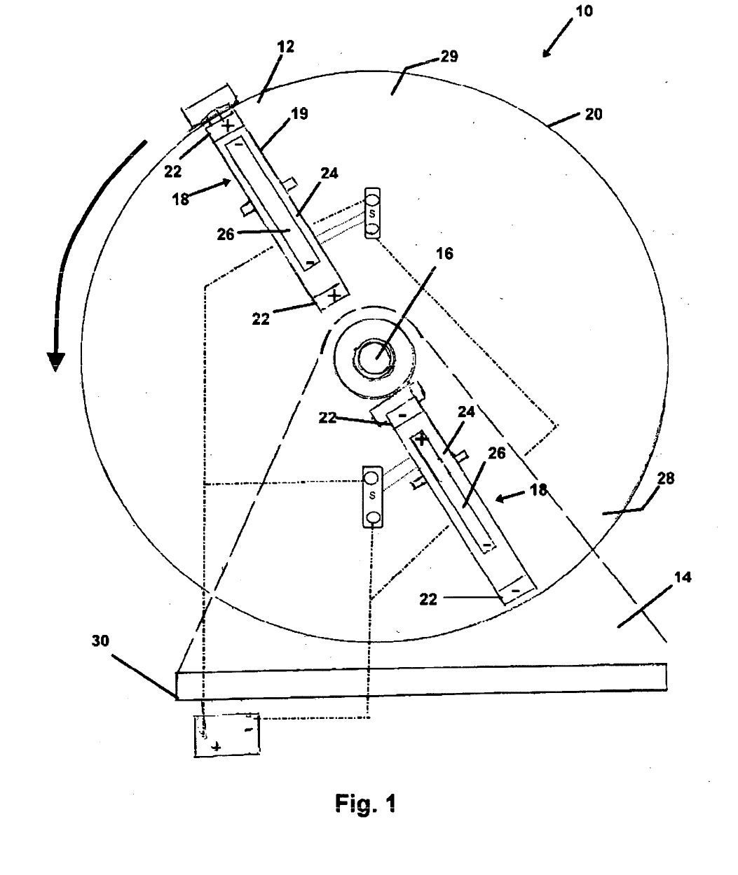

Referring now to the drawings FIGS. 1-4, wherein similar parts are identified by like reference numerals, there is seen in FIG. 1, the device 10 operating pursuant to the method herein.

The illustration of FIG. 1, which is not to scale, depicts the novel principal and method under which the device 10 herein operates in all modes and shows a wheel 12 operatively engaged for rotation with a frame 14 on a centrally located axle 16.

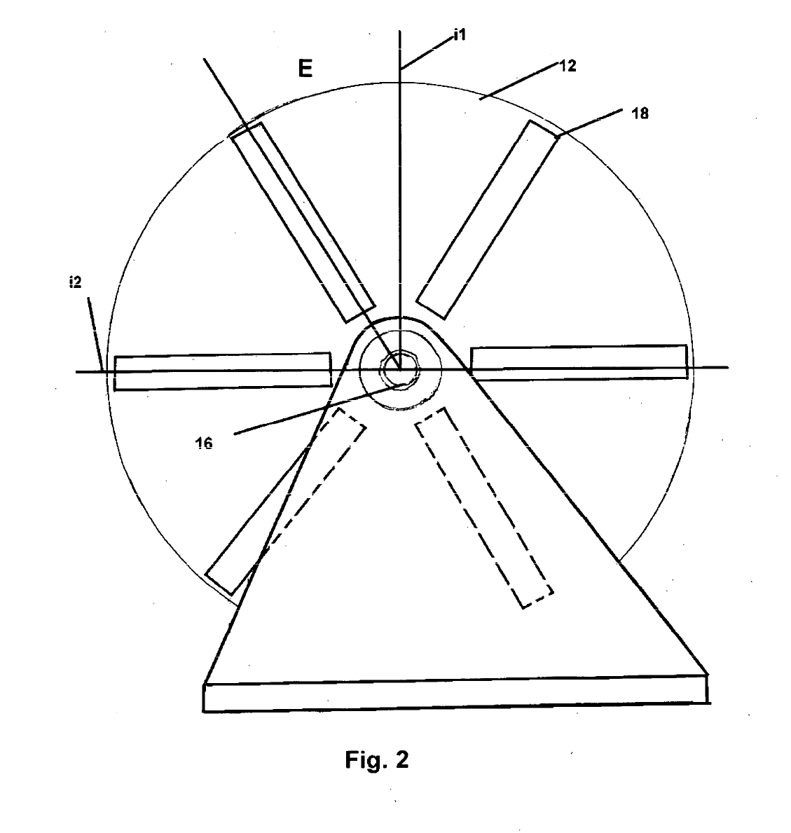

Located on the wheel 12 is a plurality of magnetic assemblies 18 which are to be located running along lines radially between the axle 16 and edge of the wheel 12. Such an opposing radial location of a plurality of assemblies 18 is generally depicted in FIG. 2. However, the number of assemblies 18, their spacing, their size relative to the diameter of the wheel 12, and other mechanical and positional considerations may change.

Shown in FIG. 2, the assemblies 18 extend along radial lines or vectors running between the axle 16 and edge 20 of the wheel, about fixed positions on the wheel 12. As shown in FIG. 1, in a particularly preferred mode of the device 10, each assembly 18 has a pair of pole-reversible electromagnets 22 positioned on opposite sides of a gap 24. A respective magnetically-translated member such as the preferred permanent magnet 26, a solenoid, linear engine, or other translating mass, is positioned in each gap 24, between each respective pair of pole-reversible electromagnets 22, of each assembly 18.

During operation of the device, to induce a continuous out of balance condition, to rotate the wheel 12, the assemblies are sequentially energized. In this operation a first assembly 18 from said plurality of assemblies radially located in spaced positions between the axle 16 and the wheel circumferential edge 20, located in a lower or bottom portion 28 of the wheel 12, below line i2 of FIG. 2, or closest to a support surface 30 for the frame 14, and a second assembly 19 located at an upper portion 29 of the wheel 12, above line i2, and radially opposing the first assembly 18, will both have electrical current communicated thereto.

The electric current, using means for switching polarity, is continually switched to respective energized states of both the first assembly, and opposing second assembly 19, such that the magnetically translated member, such as permanent magnet 26, concurrently move along vectors in the same direction, to thereby position the respective permanent magnets 26 in respective positions in each assembly, to create the noted out-of-balance condition of the wheel.

In this operation, using the depicted components in FIG. 1, the polarity of the energized state of each first assembly 18 and second assembly 19, upon reaching opposite radial positions during rotation of the wheel 14, will sequentially reverse at a moment each respective assembly reaches the appropriate energizing position on the wheel 14. Generally speaking, this energizing position “E” occurs when the assembly 18 in a pair moves in the direction of rotation of the wheel 12 from a quadrant in the rotation on one side of top-dead-center which is the intersection of line i1 with the edge 20 and into the next quadrant in the direction of rotation. This energizing position “E” can vary between 1-15 degrees past top-dead-center at the intersection of the edge 20 and the first imaginary line i1 in the depicted direction of wheel rotation toward the level second imaginary line i2. Of course such is reversed if the wheel direction is reversed.

During the energized state, in a first operation, electric current is communicated through a switch 32 or other means for communicating electrical current in a particular polarity, in a manner to cause the electromagnets 22 located on the elevated or second assembly 19, positioned in the top portion 29 of the wheel 14 above imaginary line i2 (FIG. 2), to achieve a polarity for approximately one second to energize both electromagnets 22 therein, to causing a repelling of the negative end 40 of the magnetically translated member such as the permanent magnet 26, located in the gap 24 in a direction toward the circumferential edge 20 of the wheel 12.

Substantially concurrent with the duration of the energized state “E” of the first operation, in a second operation the opposing first assembly 18 located along a radial line at the opposite side of the wheel 12, from the elevated second assembly 19, is communicated electric current adapted to charge both electromagnets 22 on both sides of the gap 24, of this first assembly 18 to move in a direction toward the axle 16.

Subsequent to the concurrent communication of electrical power, in polarities to each respective assembly in a radially located pair, to initiate the first and second operations during the energized state “E”, the respective magnetically-translated member such as the shown permanent magnets 26 located within the gap 24 between each respective pair of electromagnets 22, in each respective assembly 18, will remain in a removable magnetic engagement to the electromagnet 22 to which it was electromagnetically forced. This magnetic removable engagement of the magnetically translated members such as the shown permanent magnets 26 of the assemblies 18, will remain in this engaged state until the electrical current to each respective assembly 18 is reversed in polarity, at a position where each respective magnetic assembly 18, rotates to a position at the opposite end of the wheel 12 during rotation thereof.

As noted, the plurality of magnetic assemblies 18 are radially spaced substantially equidistant in positions between the axle and edge 20, along radial lines running the entire circumference of the wheel 12. Each member of this plurality of magnetic assemblies 18, during operation is paired with an opposing magnetic assembly 18 positioned substantially along a radial line running across the wheel 12 running through the axis provided by the axle 16 on which the wheel 12 rotates.

As noted, as these opposing magnetic assemblies 18 are energized when one of the pair achieves an angle past top-dead-center and enters the energized state “E”, around the rotation of the wheel 12. Both the respective first and second operations are activated by electrical switching of the electrical current communicated to each respective opposing-positioned assembly 18 in the pair during the energized state “E”. This causes the noted acceleration and translation of the magnetically translated member such as permanent magnets 26 of the opposing assemblies 18 as noted, to concurrently move and render the wheel 12 out of balance and impart rotational force thereto.

As will occur to those skilled in the art, the rotation of direction of the wheel 12 can be reversed or slowed by changing the position of the energizing state “E” to a position on an opposite side of the top-dead-center location depicted as the intersection of imaginary line i1 in figure two.

Additionally as noted, while the current employment of a translating permanent magnet 26 between two opposing electromagnets 22 has shown to provide excellent results in imparting rotational force to the wheel 12. The magnetically translated member can be any elongated member component configured to translate due to magnetic attraction and repulsion, such as a solenoid or linear motor or permanent magnet which need not be depicted since they are well known components in the art. In the case of a solenoid or linear motor, the acceleration of the magnetically translated member can be enhanced by communication of the appropriate magnetic field to the solenoid or linear motor, to move the member in the appropriate direction for the assembly 18 of the pair of assemblies 18 activated during the energized state “E”.

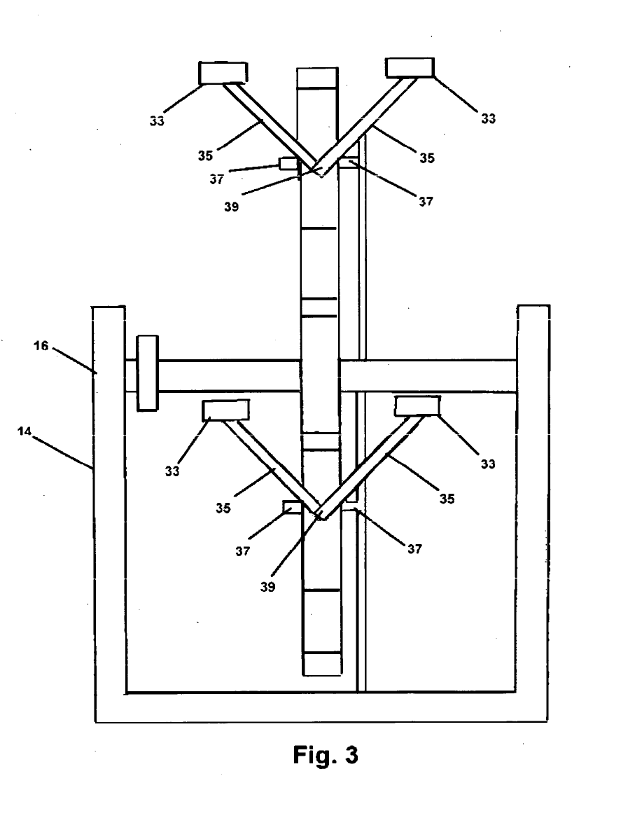

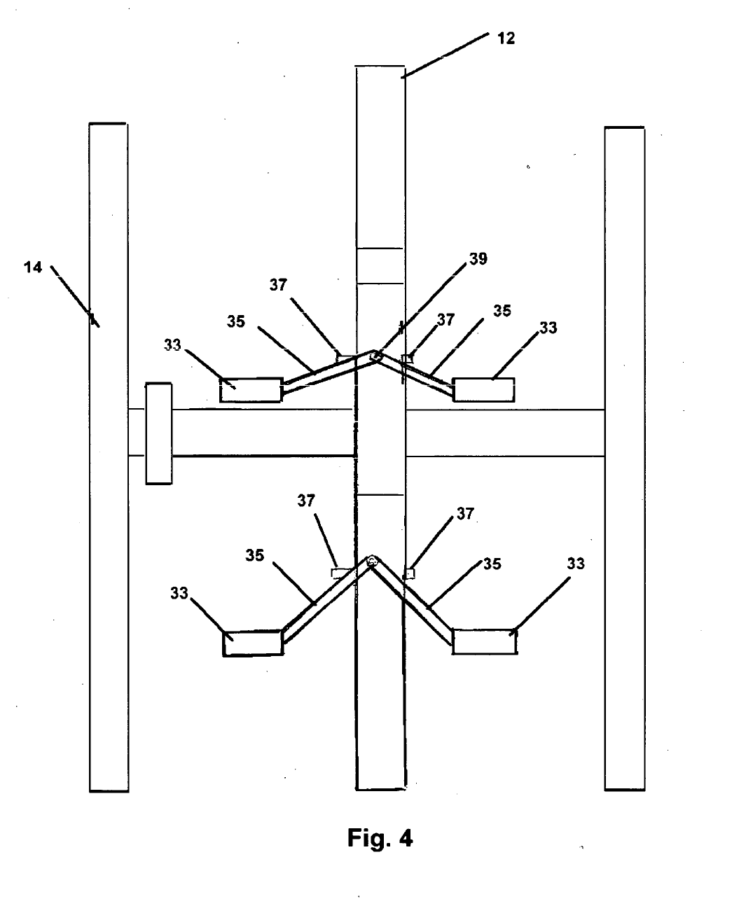

An enhanced mode of the device 10 is depicted in FIGS. 3-4 where the out of balance state of the wheel 12, and the power generated by the wheel 12 to do work, is significantly enhanced. This is accomplished by the positioning of weights 33 to either one of two positions, between the axle 16 and the circumferential edge 20 of the wheel 12, concurrent with the movement of the operatively engaged magnetically translated member, such as a permanent magnet 26. The permanent magnet 26 which as shown herein and defines a preferred translating member of each assembly 18, is operatively engaged to a pair of rotationally engaged members 35, which in turn are operatively connected in a scissor-like fashion, to the translating member or permanent magnet 26 of the magnetic assembly 18, by connectors 37.

In operative use with the device 10 in the enhanced mode of FIGS. 3-4, as the permanent magnet 26 translates toward one side or the other, of a respective magnetic assembly 18, the connectors 37 operationally engaged with the rotationally engaged members 35, cause them to rotate on a pivot point 39, engaged with the magnetic assembly 18. This rotation of the members 35 caused by the force of the translating permanent magnet 26 which is communicated to the members 35 at the attachment with the connectors 37, causes movement of the weights 33 at the distal end of each member 35, concurrently with and in the same direction as, the translating permanent magnet 26. This movement of weights 33 concurrent with and in the same direction as the translation of the translating member formed by the permanent magnet 26 of each assembly 18, imparts a significant enhancement of the out-of-balance state to the wheel 12, and thereby enhances the force which may be generated by the wheel 12.

The method and components shown in the drawings and described in detail herein disclose arrangements of elements of particular construction, and configuration for illustrating preferred embodiments of structure of the present compressor invention. It is to be understood, however, that elements of different construction and configuration, and using different steps and process procedures, and other arrangements thereof, other than those illustrated and described, may be employed for an engine system in accordance with the spirit of this invention.

As such, while the present invention has been described herein with reference to particular embodiments thereof, a latitude of modifications, various changes and substitutions are intended in the foregoing disclosure, and will be appreciated that in some instance some features of the invention could be employed without a corresponding use of other features, without departing from the scope of the invention as set forth in the following claims. All such changes, alternations and modifications as would occur to those skilled in the art are considered to be within the scope of this invention as broadly defined in the appended claims.

Further, the purpose of the foregoing abstract of the invention, is to enable the U.S. Patent and Trademark Office and the public generally, and especially the scientists, engineers, and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting, as to the scope of the invention in any way.

What is claimed is:

1. A motor comprising:
a wheel operatively engaged to rotate on an axle;
a plurality of magnetic assemblies radially positioned on said wheel between said axle and a circumferential edge of said wheel;
each of said plurality of magnetic assemblies being one of an assembly pair, with an opposing said magnetic assembly located on an opposite side of said wheel;
a magnetically translated member slidably located within each said assembly in a gap in-between opposing electromagnets;
means to communicate electric power to said electromagnets in each said magnetic assembly, in each respective assembly pair, at an energizing point during rotation of said wheel;
said energizing point occurring only when one respective said magnetic assembly at an elevation higher than the other assembly of a respective assembly pair, rotates to or past a top-dead-center position in a direction of rotation of said wheel;
said electrical power communicated generating a magnetic force from both said electromagnets in each respective said assembly in a said assembly pair, to impart movements of both respective said magnetically translating members, in both of said magnetic assemblies in the same direction, thereby imparting a first movement of said translating member of said assembly located at said higher elevation closer to said circumferential edge, and imparting concurrent second movement of said translating member of the other of said assembly pair, in a direction away from said circumferential edge and toward said axle; and
said concurrent first movement and second movements imparting an out-of-balance condition to said wheel, whereby rotational force is communicated to said wheel.

2. The motor of claim 1, wherein said translating member is a permanent magnet.

3. The motor of claim 2 wherein said means to communicate electric power to said electromagnets in each said magnetic assembly, in each respective assembly pair, comprises:
wiring to communicate said electric power from a power source to each respective said magnetic assembly;
a switch operatively engaged with said wiring between said power source and each said assembly; and
said switch configured to communicate said electric power to a first said assembly in each said assembly pair in a first polarity, and communicate said electric power to the second said assembly in each assembly pair in the opposite polarity of said first polarity.

4. The motor of claim 1, additionally comprising:
a pair of weights engaged to one of a respective pair of rotationally engaged weight members, positioned at or adjacent to both ends, of each said magnetic assembly;
a connector engaging each respective weight member of each respective pair of weight members, with the magnetically translated member of each respective assembly;
said pair of weights positioned at both ends of each said magnetic assembly, moving concurrent with and in the same direction of, the magnetically translating member of the respective assembly to which it is engaged; and
whereby said out-of-balance condition imparted to said wheel is enhanced by a weight of said pair of weights positioned at both ends of said magnetic assembly.

5. The motor of claim 2, additionally comprising:
a pair of weights engaged to one of a respective pair of rotationally engaged weight members, positioned at or adjacent to both ends, of each said magnetic assembly;
a connector engaging each respective weight member of each respective pair of weight members, with the magnetically translated member of each respective assembly;
said pair of weights positioned at both ends of each said magnetic assembly, moving concurrent with and in the same direction of, the magnetically translating member of the respective assembly to which it is engaged; and
whereby said out-of-balance condition imparted to said wheel is enhanced by a weight of said pair of weights positioned at both ends of said magnetic assembly.

6. A method of imparting rotational force to a wheel by inducing a continuous out-of-balance condition to said wheel, employing the components of claim 1.

7. A method of imparting rotational force to a wheel by inducing a continuous out-of-balance condition to said wheel, employing the components of claim 2.

8. A method of imparting rotational force to a wheel by inducing a continuous out-of-balance condition to said wheel, employing the components of claim 3.

9. A method of imparting rotational force to a wheel by inducing a continuous out-of-balance condition to said wheel, employing the components of claim 4.

10. A method of imparting rotational force to a wheel by inducing a continuous out-of-balance condition to said wheel, employing the components of claim 5.
